(19) United States
(12) Patent Application Publication
(10) Pub. No.: US 2023/0238013 A1
(43) Pub. Date: Jul. 27, 2023

(54) Sound Processing Apparatus and Sound Processing Method

(71) Applicant: Yamaha Corporation, Hamamatsu-shi (JP)

(72) Inventors: Masashi SUZUKI, Hamamatsu-shi (JP); Satoshi UKAI, Hamamatsu-shi (JP)

(21) Appl. No.: 18/098,522

(22) Filed: Jan. 18, 2023

(30) Foreign Application Priority Data
Jan. 21, 2022 (JP) 2022-007557

(51) Int. Cl. G10L 21/0232

(52) U.S. Cl. CPC G10L 21/0232

(57) ABSTRACT

A sound processing apparatus includes sound collection circuity that collects a sound and generates a first sound signal, and processing circuitry that estimates an estimated noise, controls a gain of the first sound signal and outputs a second sound signal based on the estimated noise, performs filter processing to reduce a component of a predetermined frequency band of the second sound signal based at least in part on the estimated noise.

### CROSS REFERENCE TO RELATED APPLICATIONS

This Nonprovisional application claims priority under 35 U.S.C. § 119(a) on Patent Application No. 2022-007557 filed in Japan on Jan. 21, 2022, the entire contents of which is hereby incorporated by reference.

### BACKGROUND

### Technical Field

The present disclosure relates to a sound processing apparatus and a sound processing method, and more particularly relates to a technology to reduce noise.

### Background Information

Japanese Unexamined Patent Application Publication No. 2010-122617 discloses a noise gate that estimates a noise spectrum of stationary noise based on a frequency spectrum of a sound signal. The noise gate, in a case in which a signal level ratio of the frequency spectrum of the sound signal to a noise spectrum is greater than or equal to a threshold value, outputs the frequency spectrum as it is. The noise gate, in a case in which the signal level ratio of the frequency spectrum of the sound signal to the noise spectrum is less than a threshold value, decreases and outputs a gain.

In a case in which a gain control is performed according to a ratio (S/N) of a noise level to a sound level, noise is mixed when a voice of a talker is inputted.

### SUMMARY

In view of the foregoing, one aspect of the present disclosure is directed to providing a sound processing apparatus capable of reducing noise when inputting a voice of a talker.

A sound processing apparatus includes sound collection circuity that collects a sound and generates a first sound signal, and processing circuitry that estimates an estimated noise, controls a gain of the first sound signal and outputs a second sound signal, based on the estimated noise, and performs filter processing to reduce a component of a predetermined frequency band of the second sound signal based at least in part on the estimated noise.

According to an embodiment of the present disclosure, noise is able to be reduced when a voice of a talker is inputted.

### BRIEF DESCRIPTION OF THE DRAWINGS

FIG. 1 is a block diagram showing a configuration of a sound processing apparatus 1.

FIG. 2 is a block diagram showing a functional configuration of a processor 12.

FIG. 3 is a flow chart showing an operation of the processor 12.

FIG. 4 is a graph showing a relationship between a gain and an S/N of a noise reducer 121.

FIG. 5 is a graph showing a relationship between a gain of an EQ 122 and a noise power estimation value.

FIG. 6 is a table showing an estimation result of a noise component of each of a plurality of frequency bands.

FIG. 7 is a graph showing a time change of the noise power estimation value.

FIG. 8 is a graph showing a time change of the noise power estimation value in a case in which the noise power estimation value is obtained based on noise power of a certain band (0 to 250 Hz, for example), as a reference example.

FIG. 9 is a block diagram showing a functional configuration of a processor 12 according to a second modification.

FIG. 10 is a graph showing a relationship between the gain of the EQ 122 and the noise power estimation value.

FIG. 11 shows graphs showing a relationship between the gain of the EQ 122 and the noise power estimation value in a case in which a gain for each band is changed.

### DETAILED DESCRIPTION

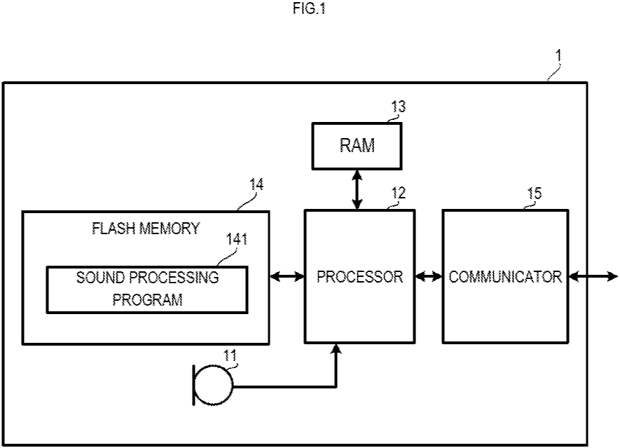

FIG. 1 is a block diagram showing a configuration of a sound processing apparatus 1. The sound processing apparatus 1 includes a microphone 11, a processor 12, a RAM 13, a flash memory 14, and a communicator 15.

The microphone 11 collects a sound. In various embodiments, the microphone 11 constitutes the sound collection circuitry. The processor 12 sends a sound signal of the sound collected by the microphone 11, to an external personal computer (PC) or the like, through the communicator 15.

The processor 12 includes a CPU, a DSP, or an SoC (System on a Chip). The processor 12 reads out a program from the flash memory 14 being a storage medium, and temporarily stores the program in the RAM 13, and thus performs various operations. The program includes a sound processing program 141.

The flash memory 14 stores a program for operating the processor 12. For example, the flash memory 14 stores the sound processing program 141. The processor 12 executes the sound processing method of the present disclosure by the sound processing program 141. In various embodiments, the processor 12 constitutes the processing circuitry.

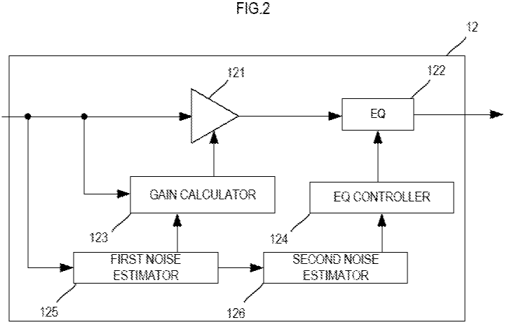

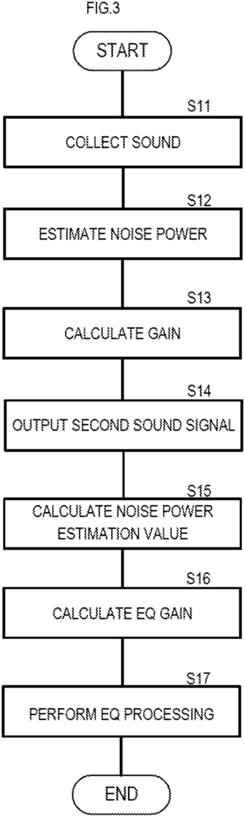

FIG. 2 is a block diagram showing a functional configuration of the processor 12. FIG. 3 is a flow chart showing an operation of the sound processing method. The processor 12 includes a noise reducer 121, an equalizer (EQ) 122, a gain calculator 123, an EQ controller 124, a first noise estimator 125, and a second noise estimator 126. The functional configurations are configured by the sound processing program 141. The noise reducer 121 and the gain calculator 123 are examples of a gain controller of the present disclosure. The EQ 122 and the EQ controller 124 are examples of a filter of the present disclosure.

The microphone 11 collects a sound and generates a first sound signal (S11). The sound includes a voice of a talker or noise. The microphone 11 outputs a generated first sound signal to the processor 12.

First, the first noise estimator 125 estimates noise power based on the first sound signal (S12). The method of estimating noise power may be any method. For example, the first noise estimator 125 estimates the minimum value in a power average value in a predetermined section of the first sound signal, as noise power.

The gain calculator 123 calculates a gain of the first sound signal in the noise reducer 121 based on the noise power estimated by the first noise estimator 125 (S13). For example, the gain calculator 123 determines a gain of the noise reducer 121 based on a ratio (S/N) of power S and noise power N of the first sound signal so as to cause the noise reducer 121 to function as a Wiener filter.

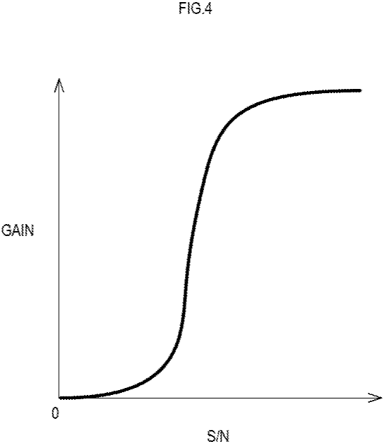

FIG. 4 is a graph showing a relationship between the gain and the S/N of the noise reducer 121. The horizontal axis of the graph of FIG. 4 indicates the S/N, and the vertical axis indicates the gain of the noise reducer 121. The gain calculator 123, as shown in FIG. 4, decreases the gain of the noise reducer 121 when the S/N is small and increases the gain of the noise reducer 121 when the S/N is large.

The noise reducer 121 inputs the first sound signal by the gain calculated by the gain calculator 123, and outputs a second sound signal (S14). As a result, the noise reducer 121 reduces noise in order to decrease a level of the second sound signal when a talker is not talking. On the other hand, the noise reducer 121 does not reduce the voice of the talker in order to increase the level of the second sound signal when the talker is talking.

The second noise estimator 126 estimates noise based on a part of a band of the first sound signal. For example, the second noise estimator 126 obtains a noise power estimation value based on noise power of 1 kHz or less among the noise power calculated by the first noise estimator 125 (S15).

The EQ controller 124 calculates a gain of the EQ 122 based on the noise power estimation value obtained by the second noise estimator 126 (S16). The EQ 122 performs processing to reduce a component in a predetermined frequency band of the second sound signal based on the gain calculated by the EQ controller 124 (S17). For example, the EQ 122 reduces a band of 1 kHz or less of the second sound signal.

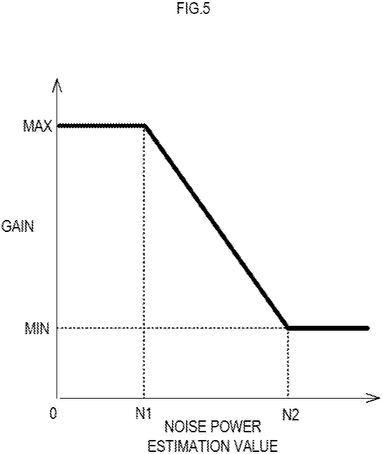

FIG. 5 is a graph showing a relationship between the gain of the EQ 122 and the noise power estimation value. The horizontal axis of the graph of FIG. 5 indicates the noise power estimation value, and the vertical axis indicates the gain of the EQ 122. The EQ controller 124, as shown in FIG. 5, increases the gain of the EQ 122 when the noise power estimation value is small, and decreases the gain of the EQ 122 when the noise power estimation value is large. The EQ controller 124, in the example of FIG. 5, sets the gain of the EQ 122 to the maximum value (0 dB, for example) when the noise power estimation value is smaller than a predetermined value N1. In short, in a case in which the noise power estimation value is smaller than the predetermined value N1, reduction processing in the EQ 122 is not performed. The EQ controller 124, in the example of FIG. 5, sets the gain of the EQ 122 to the minimum value (-36 dB, for example) when the noise power estimation value is larger than a predetermined value N2. The EQ controller 124 linearly varies the gain of the EQ 122 according to the noise power estimation value, in a case in which the noise power estimation value is greater than or equal to the predetermined value N1 and less than or equal to the predetermined value N2.

As described above, the noise reducer 121 reduces noise in order to decrease the level of the second sound signal when a talker is not talking. On the other hand, the noise reducer 121 increases the level of the second sound signal when the talker is talking, so that noise may be mixed with the second sound signal. In particular, noise included in a low frequency band of 1 kHz or less is auditorily noticeable. However, the EQ 122 and the EQ controller 124 according to the present embodiment reduce the low frequency band of 1 kHz or less based on the noise power estimation value, so that the noise when the voice of a talker is inputted is able to be reduced. In addition, the EQ controller 124 according to the present embodiment sets the gain of the EQ 122 only based on the noise power estimation value without depending on the power of the first sound signal. Therefore, stationary noise is able to be reduced without depending on a level of the voice of a talker.

### First Modification

The second noise estimator 126 may estimate a noise component in each of a plurality of frequency bands, and may estimate noise based on an estimation result of the noise component of each of the plurality of frequency bands.

For example, the second noise estimator 126 obtains noise power of each of Band 1 of 0 to 250 Hz, Band 2 of 250 to 500 Hz, Band 3 of 500 to 750 Hz, and Band 4 of 750 to 1000 Hz. However, the number of bands and the bandwidth are not limited to this example.

Furthermore, the second noise estimator 126 weights the noise power in each band. Weight increases a band having a large auditory effect and decreases a band having a small auditory effect. For example, the second noise estimator 126 sets a weighting coefficient of Band 1 as 0.8, a weighting coefficient of Band 2 as 0.1, a weighting coefficient of Band 3 as 0.05, and a weighting coefficient of Band 4 as 0.05, multiplies the noise power of each band by each weighting coefficient, and calculates an expectation value. The second noise estimator 126 adds the expectation value of each band. The second noise estimator 126 sets an addition result as a noise power estimation value.

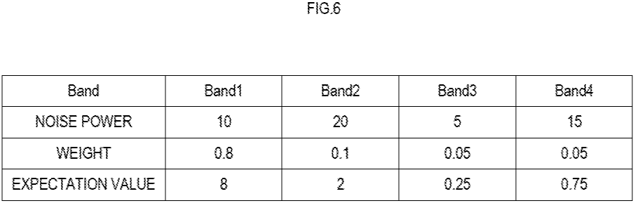

FIG. 6 is a table showing an estimation result of a noise component of each of a plurality of frequency bands. The second noise estimator 126 respectively obtains the noise power of Band 1, Band 2, Band 3, and Band 4 as 10 dB, 20 dB, 5 dB, and 15 dB. The second noise estimator 126 multiplies the weighting coefficient of each band, and respectively obtains the expectation value of Band 1, Band 2, Band 3, and Band 4 as 8, 2, 0.25, and 0.75. The second noise estimator 126 adds the expectation value of each band, and obtains the noise power estimation value = 11.

In such a manner, the second noise estimator 126 estimates noise by separating a band that is able to be predicted to be more affected by the noise and a band that is able to be predicted to be less affected by the noise. As a result, the second noise estimator 126 is able to stabilize filter processing by the EQ 122.

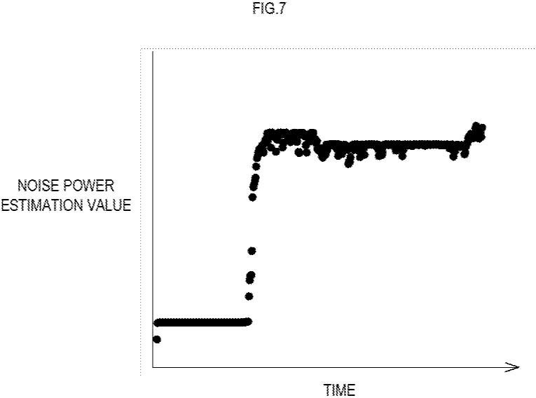

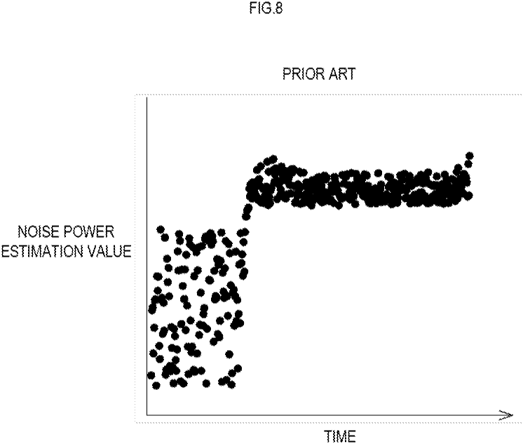

FIG. 7 is a graph showing a time change of the noise power estimation value obtained by the second noise estimator 126, and FIG. 8 is a graph showing a time change of the noise power estimation value in a case in which the noise power estimation value is obtained based on noise power of a certain band (0 to 250 Hz, for example), as a reference example.

As shown in FIG. 8, in a case in which a noise power estimation value is obtained based on the noise power of a certain band (0 to 250 Hz, for example), the noise power may be momentarily increased or decreased in the band, and the noise power estimation value varies. Therefore, the gain of the EQ 122 may vary.

In contrast, as shown in FIG. 7, the second noise estimator 126 of the first modification obtains each noise power in a plurality of frequency bands, and, even in a case in which weighting addition momentarily increases or decreases the noise power in a certain band, the noise power estimation value does not vary. Therefore, the second noise estimator 126 of the first modification is able to stabilize the gain of the EQ 122.

It is to be noted that the EQ 122 may perform the filter processing in a band narrower than a plurality of frequency bands (Band 1 to Band 4) estimated by the second noise estimator 126. For example, the EQ 122 may perform the filter processing only on the band (Band 1, for example) having the largest auditory effect. As a result, the EQ 122 is able to minimize a change in sound quality.

### Second Modification

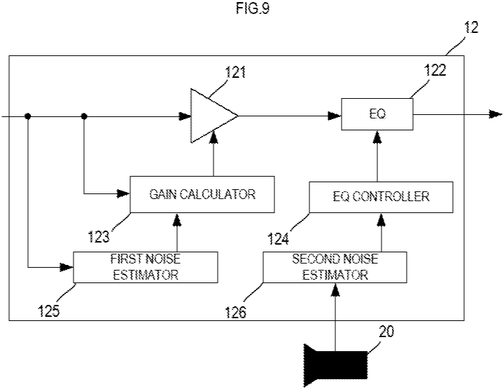

The first noise estimator 125 or the second noise estimator 126 may obtain image data, and may estimate noise based on obtained image data. FIG. 9 is a block diagram showing a functional configuration of a processor 12 according to a second modification. In this example, the sound processing apparatus 1 includes a camera 20 to obtain image data. In addition, in this example, the second noise estimator 126 obtains the image data from the camera 20, and estimates noise based on the obtained image data.

Specifically, the second noise estimator 126 recognizes a noise source included in the image data, and obtains the noise power estimation value according to the state of a recognized noise source. The noise source includes a person, a PC, an air conditioner, a ventilation fan, or a vacuum cleaner, for example.

The second noise estimator 126 obtains the noise power estimation value based on the number of movable objects (pedestrians, for example) to be recognized within a predetermined time, for example. The second noise estimator 126 estimates that the noise power estimation value is increased as the number of movable objects (pedestrians, for example) recognized within the predetermined time is increased, and estimates that the noise power estimation value is decreased as the number of movable objects (pedestrians, for example) recognized within the predetermined time is decreased.

Alternatively, the second noise estimator 126 may obtain the noise power estimation value based on the number of persons at a distant place. The second noise estimator 126 may recognize the image of an air conditioner, and may obtain the noise power estimation value based on a state (the number of rotations of a fan, for example) of the air conditioner. Alternatively, the second noise estimator 126 may obtain the noise power estimation value based on a state (a degree of swinging of a curtain, for example) of an object around the air conditioner. Alternatively, the second noise estimator 126 may recognize a remote controller of the air conditioner, and may obtain the noise power estimation value based on a set temperature displayed on the remote controller. The second noise estimator 126, in a case of the air conditioner in cooling operation, estimates that the noise power estimation value is increased as the set temperature is decreased, and estimates that the noise power estimation value is decreased as the set temperature is increased. The second noise estimator 126, in a case of the air conditioner in heating operation, estimates that the noise power estimation value is increased as the set temperature is increased, and estimates that the noise power estimation value is decreased as the set temperature is decreased.

It is to be noted that the first noise estimator 125 may obtain image data from the camera 20 and may estimate noise based on obtained image data, or both of the first noise estimator 125 and the second noise estimator 126 may obtain image data from the camera 20 and may estimate noise based on obtained image data. In addition, the first noise estimator 125 or the second noise estimator 126 may estimate noise power based on the first sound signal and the image data.

The description of the foregoing embodiments is illustrative in all points and should not be construed to limit the present disclosure. The scope of the present disclosure is defined not by the foregoing embodiments but by the following claims. Further, the scope of the present disclosure includes the scopes of the claims and the scopes of equivalents.

For example, the EQ controller 124 may calculate the gain of the EQ 122 based on the noise power estimation value obtained by the first noise estimator 125. The EQ controller 124 may calculate the gain of the EQ 122 based on the ratio (S/N) of the power S to the noise power N of the first sound signal.

In addition, in FIG. 5, the EQ controller 124 linearly varies the gain of the EQ 122 according to the noise power estimation value, in a case in which the noise power estimation value is greater than or equal to the predetermined value N1 and less than or equal to the predetermined value N2. However, the EQ controller 124 does not need to linearly vary the gain of the EQ 122 according to the noise power estimation value.

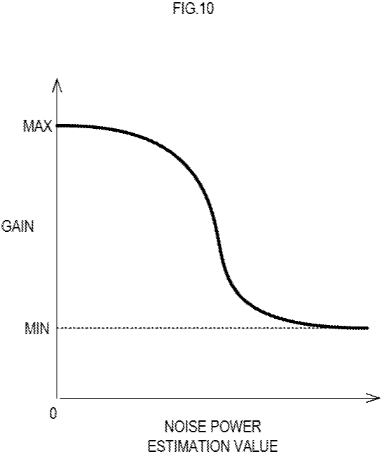

FIG. 10 is a graph showing a relationship between the gain of the EQ 122 and the noise power estimation value. The horizontal axis of the graph of FIG. 5 indicates the noise power estimation value, and the vertical axis indicates the gain of the EQ 122. As shown in FIG. 10, the EQ controller 124 may gradually vary the gain of the EQ 122 according to the noise power estimation value in a case in which the noise power estimation value is small, may drastically vary the gain of the EQ 122 in a case in which the noise power estimation value is larger to some extent, and may gradually vary the gain of the EQ 122 in a case in which the noise power estimation value is large. In addition, the EQ controller 124, in a case in which the noise power estimation value is greater than or equal to a predetermined value, may set the gain of the EQ 122 to the minimum value, and, in a case in which the noise power estimation value is less than the predetermined value, may set the gain of the EQ 122 to the maximum value.

In addition, in a case in which the second noise estimator 126 obtains the noise power in each of the plurality of frequency bands and obtains the noise power estimation value, as shown in the first modification, the EQ controller 124 may change the gain for each band of the EQ 122 based on an obtained noise power estimation value.

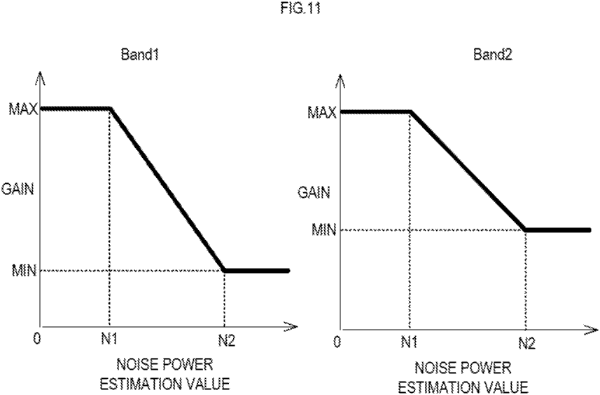

For example, FIG. 11 shows graphs showing a relationship between the gain of the EQ 122 and the noise power estimation value in a case in which a gain for each band is changed. In this example, the EQ controller 124 changes the gain of each of Band 1 and Band 2 of the EQ 122 based on the noise power estimation value. In this example, the gain of the minimum value of Band 1 is smaller than the gain of the minimum value of Band 2. In short, the amount of reduction of Band 1 is increased on the whole, and the amount of reduction of Band 2 is relatively decreased. In this example, the EQ 122 does not change the gain of Band 3 and Band 4.

In such a manner, the EQ controller 124 may change the gain of the EQ 122 based on noise power estimation value, for each band. As a result, the EQ 122 is able to minimize a change in sound quality and accurately reduce noise.

What is claimed is:

1. A sound processing apparatus comprising:
sound collection circuitry configured to collect a sound and generate a first sound signal; and
processing circuitry configured to:
estimate an estimated noise;
control a gain of the first sound signal and output a second sound signal based at least in part on the estimated noise; and
perform filter processing to reduce a component of a predetermined frequency band of the second sound signal based at least in part on the estimated noise.

2. The sound processing apparatus according to claim 1, wherein the processing circuitry is configured to estimate the estimated noise based on the first sound signal.

3. The sound processing apparatus according to claim 1, wherein the estimated noise includes a first estimated noise and a second estimated noise, wherein the processing circuitry is configured to:
estimate the first estimated noise based at least in part on the first sound signal;
estimate the second estimated noise based on a part of a band of the first sound signal;
control the gain of the first sound signal based on the first estimated noise; and
perform the filter processing based on the second estimated noise.

4. The sound processing apparatus according to claim 3, wherein the processing circuitry is configured to estimate a noise component in each of a plurality of frequency bands, and estimate the second estimated noise based on an estimation result of the noise component in each of the plurality of frequency bands.

5. The sound processing apparatus according to claim 4, wherein the processing circuitry is configured to perform the filter processing in a band narrower than the plurality of frequency bands.

6. The sound processing apparatus according to claim 1, wherein the processing circuitry is configured to increase an amount of reduction in the filter processing as a level of the estimated noise is increased.

7. The sound processing apparatus according to claim 1, wherein an amount of reduction in the filter processing has a maximum and a minimum.

8. The sound processing apparatus according to claim 1, wherein the processing circuitry is configured to obtain image data, and estimate the estimated noise based on the image data.

9. The sound processing apparatus according to claim 1, wherein processing circuitry is configured to:
control the gain based on a level of the estimated noise and a level of the first sound signal; and
perform the filter processing based at least in part on the level of the estimated noise.

10. A sound processing method comprising:
collecting a sound and generating a first sound signal;
estimating an estimated noise;
controlling a gain of the first sound signal and outputting a second sound signal based at least in part on the estimated noise; and
performing filter processing to reduce a component of a predetermined frequency band of the second sound signal based at least in part on the estimated noise.

11. The sound processing method according to claim 10, further comprising estimating the estimated noise based on the first sound signal.

12. The sound processing method according to claim 10, further comprising:
estimating the estimated noise by performing first noise estimation processing and second noise estimation processing;
wherein the first noise estimation processing comprises estimating a first estimated noise based at least in part on the first sound signal, and
wherein the second noise estimation processing comprises estimating a second estimated noise based on a part of a band of the first sound signal;
controlling the gain of the first sound signal based on the first estimated noise; and
performing the filter processing based on the second estimated noise.

13. The sound processing method according to claim 12, wherein the second noise estimation processing comprises estimating a noise component in each of a plurality of frequency bands, and estimating the second estimated noise based on an estimation result of the noise component in each of the plurality of frequency bands.

14. The sound processing method according to claim 13, further comprising performing the filter processing in a band narrower than the plurality of frequency bands.

15. The sound processing method according to claim 10, further comprising increasing an amount of reduction in the filter processing as a level of the estimated noise is increased.

16. The sound processing method according to claim 10, wherein an amount of reduction in the filter processing has a maximum and a minimum.

17. The sound processing method according to claim 10, further comprising obtaining image data, wherein the noise is estimated based on image data.

18. The sound processing method according to claim 10, further comprising:
controlling the gain based on a level of the estimated noise and a level of the first sound signal; and
performing the filter processing based on the level of the estimated noise.
